(19) United States
(12) Patent Application Publication
(10) Pub. No.: US 2022/0383333 A1
(43) Pub. Date: Dec. 1, 2022

(54) SYSTEM AND METHOD OF VALIDATING ONE OR MORE COMPONENTS OF AN INFORMATION HANDLING SYSTEM

(71) Applicant: Dell Products L.P., Round Rock, TX (US)

(72) Inventors: JASON MATTHEW YOUNG, Round Rock, TX (US); CHARLES DELBERT ROBISON, Buford, GA (US); AMY CHRISTINE NELSON, Round Rock, TX (US)

(21) Appl. No.: 17/333,783

(22) Filed: May 28, 2021

(51) Int. Cl. G06Q 30/00; G06Q 10/08; H04L 9/08; H04L 9/14

(52) U.S. Cl. CPC G06Q 30/018; G06Q 10/087; H04L 9/0822; H04L 9/14; G06Q 2220/10

(57) ABSTRACT

In one or more embodiments, one or more systems, one or more methods, and/or one or more processes may: create a manifest that includes inventory information for components of a first information handling system (IHS); encrypt, with a first private encryption key, a hash value of the manifest to produce a signature of the manifest; provide, to a second IHS, a certificate signing request that includes the manifest, the signature of the manifest, and a first public encryption key; decrypt, utilizing the first public encryption key, the signature of the manifest to obtain the hash value of the manifest; determine name-value pairs from the manifest as attributes; encrypt, with a second private encryption key, a hash value of the attributes to produce a signature of the attributes; create an attribute certificate that includes the attributes and the signature of the attributes; and provide the attribute certificate to the first IHS.

### BACKGROUND

### Field of the Disclosure

This disclosure relates generally to information handling systems and more particularly to validating one or more components of an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, one or more methods, and/or one or more processes may determine inventory information for each of multiple components of a first information handling system; may create a manifest that includes the inventory information for each of the multiple components; may determine a hash value of the manifest; may encrypt, with a first private encryption key, the hash value of the manifest to produce a signature of the manifest; may provide, to a second information handling system, a certificate signing request that includes the manifest, the signature of the manifest, and a first public encryption key associated with the first private encryption key, in which the first public encryption key is different from the first private encryption key and is utilizable to decrypt the signature of the manifest to produce the hash value of the manifest; may determine a test hash value of the manifest; may decrypt, utilizing the first public encryption key, the signature of the manifest to obtain the hash value of the manifest; may determine that the test hash value of the manifest matches the hash value of the manifest; may determine multiple name-value pairs from the manifest as multiple attributes; may determine a hash value of the multiple attributes; may encrypt, with a second private encryption key, the hash value of the multiple attributes to produce a signature of the multiple attributes; may create an attribute certificate that includes the multiple attributes, the signature of the multiple attributes, and a second public encryption key associated with the second private encryption key, in which the second public encryption key is different from the second private encryption key and is utilizable to decrypt the signature of the multiple attributes to produce the hash value of the multiple attributes; and may provide the attribute certificate to the first information handling system.

In one or more embodiments, encrypting, with the second private encryption key, the hash value of the multiple attributes to produce the signature of the multiple attributes may include: providing the hash value of the multiple attributes to a high security module; and encrypting, by the high security module and with the second private encryption key, the hash value of the multiple attributes to produce the signature of the multiple attributes. In one or more embodiments, the second private encryption key may be an original equipment manufacturer private encryption key.

In one or more embodiments, the one or more systems, the one or more methods, and/or the one or more processes may further: determine a test hash value of the multiple attributes; decrypt, utilizing the second public encryption key, the signature of the multiple attributes to obtain the hash value of the multiple attributes; and determine that the test hash value of the multiple attributes matches the hash value of the multiple attributes. For example, the one or more systems, the one or more methods, and/or the one or more processes may further: receive the attribute certificate; after receiving the attribute certificate, determine the inventory information for each of the multiple components of the information handling system; and determine that each inventory information for each of the multiple components is found in the multiple attributes.

In one or more embodiments, the one or more systems, the one or more methods, and/or the one or more processes may further: request the attribute certificate; and receive the attribute certificate. In one or more embodiments, the multiple attributes may be formatted via an abstract syntax notation one (ASN.1). In one or more embodiments, the one or more systems, the one or more methods, and/or the one or more processes may further authenticate the first public encryption key. For example, authenticating the first public encryption key may include: retrieving a test public encryption key from a memory medium of the second information handling system; and determine that the test public encryption key matches the first public encryption key.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1 illustrates an example of an information handling system, according to one or more embodiments;

FIG. 2 illustrates an example of a baseboard management controller, according to one or more embodiments;

FIGS. 3A and 3B illustrate examples of sequence diagrams of creating an attribute certificate, according to one or more embodiments;

FIG. 4A illustrates an example of a system of creating an attribute certificate, according to one or more embodiments;

FIG. 4B illustrates another example of another system of creating an attribute certificate, according to one or more embodiments;

FIG. 5 illustrates an example of a method of creating an attribute certificate, according to one or more embodiments; and

FIG. 6 illustrates an example of a method of operating a system, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are examples and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, one or more systems, one or more methods, and/or one or more processes may validate an original equipment manufacturer (OEM) information handling system that was built by an OEM. For example, one or more components of the OEM information handling system may be validated to ensure that none of the one or more components of the OEM information handling system has been replaced or tampered with while the OEM information handling system was shipped to a customer. In one or more embodiments, a test of validation may be performed on the OEM information handling system, which may determine if one or more components that were ordered by the customer and built by the OEM are present in the OEM information handling system. For example, the one or more components of the OEM information handling system may include one or more of a non-volatile memory medium (e.g., a hard drive, a solid state drive, etc.), a volatile memory medium (e.g., an amount of random access memory, etc.), a network interface card, a host bus adapter card, a discrete graphics processing unit card, a processor (e.g., a central processing unit), and a motherboard, among others.

In one or more embodiments, information associated with each of the one or more components may be collected. For example, information associated with a component may include an identifier of the component. For instance, the identifier of the component may include a string of bytes (e.g., a string of characters that may represent bytes). In one or more embodiments, a digital certificate that includes the information associated with each of the one or more components may be created. For example, a manifest that includes the information associated with each of the one or more components may be created, and a certificate signing request (CSR) may be created. In one or more embodiments, the OEM information handling system may create the CSR. For example, the CSR may include a signature that may be utilized to authenticate the manifest. In one or more embodiments, the CSR may be provided to a certificate authority. For example, the OEM information handling system may provide the CSR to the certificate authority. For instance, the certificate authority may be a certificate authority of the OEM.

In one or more embodiments, the certificate authority may utilize the signature to authenticate the manifest. In one example, the certificate authority may utilize a public key from the OEM information handling system to authenticate the manifest with the signature. In another example, the certificate authority may utilize a stored public key to authenticate the manifest with the signature. For instance, the certificate authority may trust the stored public key. In one or more embodiments, the certificate authority may utilize information of the manifest to create attributes for an attribute certificate. For example, the certificate authority may parse information of the manifest to create attributes for an attribute certificate.

In one or more embodiments, the certificate authority may create a signed attribute certificate. For example, the certificate authority may utilize a high security module (HSM) to sign the attributes of the attribute certificate. In one or more embodiments, the signed attribute certificate may be provided to the OEM information handling system. In one example, the signed attribute certificate may be provided to the OEM information handling system before the OEM information handling system is shipped. In another example, the signed attribute certificate may be provided to the OEM information handling system after the OEM information handling system is shipped and received by a customer. For instance, the customer may request the signed attribute certificate after receiving the OEM information handling system. In one or more embodiments, the signed attribute certificate may be utilized to determine if the OEM information handling system includes the components it was manufactured with. For example, the customer may utilize the signed attribute certificate to determine if the OEM information handling system includes the components it was manufactured with. For instance, the customer may utilize the signed attribute certificate to determine if the OEM information handling system includes the components that were ordered by the customer.

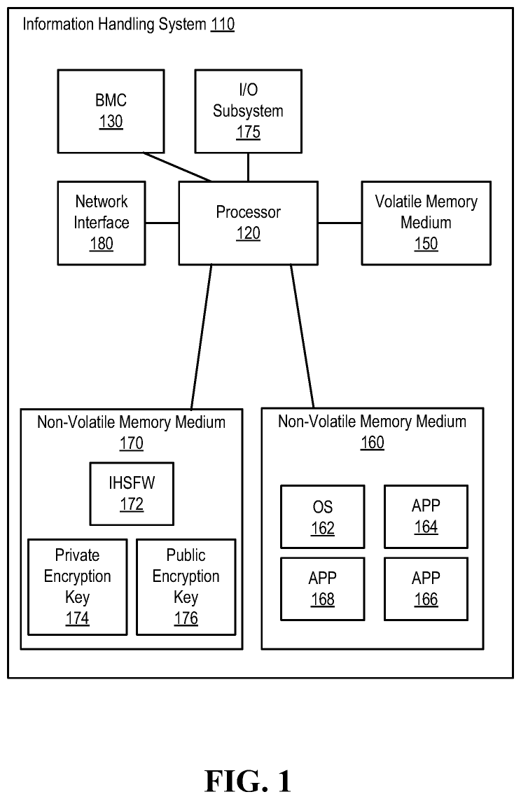

Turning now to FIG. 1, an example of an information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, a portable IHS 110 may include or have a form factor of that of or similar to one or more of a laptop, a notebook, a telephone, a tablet, and a PDA, among others. For example, a portable IHS 110 may be readily carried and/or transported by a user (e.g., a person). In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a baseboard management controller (BMC) 130, a volatile memory medium 150, non-volatile memory media 160 and 170, an I/O subsystem 175, and a network interface 180. As illustrated, BMC 130, volatile memory medium 150, non-volatile memory media 160 and 170, I/O subsystem 175, and network interface 180 may be communicatively coupled to processor 120.

In one or more embodiments, one or more of BMC 130, volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of BMC 130, volatile memory medium 150, non-volatile memory media 160 and 170, I/O subsystem 175, and network interface 180 may be communicatively coupled to processor 120 via one or more PCI-Express (PCIe) root complexes. In another example, one or more of BMC 130, I/O subsystem 175, and network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network. In one instance, the wireless network may include a cellular telephone network. In a second instance, the wireless network may include a satellite telephone network. In another instance, the wireless network may include a wireless Ethernet network (e.g., a Wi-Fi network, an IEEE 802.11 network, etc.).

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, processor 120 may execute processor instructions in implementing at least a portion of one or more systems, at least a portion of one or more flowcharts, at least a portion of one or more methods, and/or at least a portion of one or more processes described herein. In one example, processor 120 may execute processor instructions from one or more of memory media 150, 160, and 170 in implementing at least a portion of one or more systems, at least a portion of one or more flowcharts, at least a portion of one or more methods, and/or at least a portion of one or more processes described herein. In another example, processor 120 may execute processor instructions via network interface 180 in implementing at least a portion of one or more systems, at least a portion of one or more flowcharts, at least a portion of one or more methods, and/or at least a portion of one or more processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150, 160, and 170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or one or more functionalities of and/or compliant with one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, non-volatile memory medium 170 may include a private encryption key 174. In one or more embodiments, non-volatile memory medium 170 may include a public encryption key 176. In one or more embodiments, private encryption key 174 may be different from public encryption key 176. For example, private encryption key 174 and public encryption key 176 may be asymmetric encryption keys. In one instance, data encrypted via private encryption key 174 may be decrypted via public encryption key 176. In another instance, data encrypted via public encryption key 176 may be decrypted via private encryption key 174.

In one or more embodiments, processor 120 and one or more components of IHS 110 may be included in a system-on-chip (SoC). For example, the SoC may include processor 120 and a platform controller hub (not specifically illustrated).

In one or more embodiments, BMC 130 may be or include a remote access controller. For example, the remote access controller may be or include a DELL™ Remote Access Controller (DRAC). In one or more embodiments, a remote access controller may be integrated into IHS 110. For example, the remote access controller may be or include an integrated DELL™ Remote Access Controller (iDRAC). In one or more embodiments, a remote access controller may include one or more of a processor, a memory, and a network interface, among others. In one or more embodiments, a remote access controller may access one or more busses and/or one or more portions of IHS 110. For example, the remote access controller may include and/or may provide power management, virtual media access, and/or remote console capabilities, among others, which may be available via a web browser and/or a command line interface. For instance, the remote access controller may provide and/or permit an administrator (e.g., a user) one or more abilities to configure and/or maintain an information handling system as if the administrator was at a console of the information handling system and/or had physical access to the information handling system.

In one or more embodiments, a remote access controller may interface with baseboard management controller integrated circuits. In one example, the remote access controller may be based at least on an Intelligent Platform Management Interface (IPMI) standard. For instance, the remote access controller may allow and/or permit utilization of IPMI out-of-band interfaces such as IPMI Over LAN (local area network). In another example, the remote access controller may be based at least on a Redfish standard. In one instance, one or more portions of the remote access controller may be compliant with one or more portions of a Redfish standard. In another instance, one or more portions of the remote access controller may implement one or more portions of a Redfish standard. In one or more embodiments, a remote access controller may include and/or provide one or more internal private networks. For example, the remote access controller may include and/or provide one or more of an Ethernet interface, a front panel USB interface, and a Wi-Fi interface, among others. In one or more embodiments, a remote access controller may be, include, or form at least a portion of a virtual KVM (keyboard, video, and mouse) device. For example, a remote access controller may be, include, or form at least a portion of a KVM over IP (IPKVM) device. For instance, a remote access controller may capture video, keyboard, and/or mouse signals; may convert the signals into packets; and may provide the packets to a remote console application via a network.

In one or more embodiments, BMC 130 may be or include a microcontroller. For example, the microcontroller may be or include an 8051 microcontroller, an ARM Cortex-M (e.g., Cortex-M0, Cortex-M1, Cortex-M3, Cortex-M4, Cortex-M7, etc.) microcontroller, a MSP430 microcontroller, an AVR (e.g., 8-bit AVR, AVR-32, etc.) microcontroller, a PIC microcontroller, a 68HC11 microcontroller, a ColdFire microcontroller, and a Renesas microcontroller, among others. In one or more embodiments, BMC 130 may be or include an application processor. In one example, BMC 130 may be or include an ARM Cortex-A processor. In another example, BMC 130 may be or include an Intel Atom processor. In one or more embodiments, BMC 130 may be or include one or more of a field programmable gate array (FPGA) and an ASIC, among others, configured, coded, and/or encoded with instructions in accordance with at least a portion of one or more of systems, at least a portion of one or more flowcharts, at least a portion of one or more methods, and/or at least a portion of one or more processes described herein.

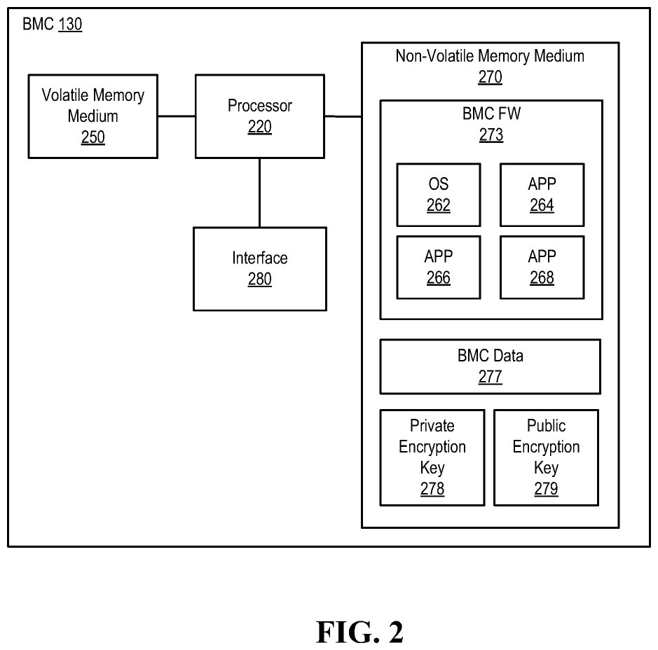

Turning now to FIG. 2, an example of a baseboard management controller is illustrated, according to one or more embodiments. As shown, BMC 130 may include a processor 220, a volatile memory medium 250, a non-volatile memory medium 270, and an interface 280. As illustrated, non-volatile memory medium 270 may include a BMC firmware (FW) 273, which may include an OS 262 and APPs 264-268, and may include BMC data 277. In one example, OS 262 may be or include a real-time operating system (RTOS). For instance, the RTOS may be or include FreeRTOS, OpenRTOS, SafeRTOS, QNX, ThreadX, VxWorks, NuttX, TI-RTOS, eCos, MicroC/OS, or Zephyr, among others. In a second example, OS 262 may be or include an Unix-like operating system. For instance, the Unix-like operating system may be or include LINUX®, FREEBSD®, NETBSD®, OpenBSD, Minix, Xinu, or Darwin, among others. In another example, OS 262 may be or include a portable operating system interface (POSIX) compliant operating system. As illustrated, non-volatile memory medium 270 may include a private encryption key 278. As shown, non-volatile memory medium 270 may include a public encryption key 279. In one or more embodiments, private encryption key 278 may be different from public encryption key 279. For example, private encryption key 278 and public encryption key 279 may be asymmetric encryption keys. In one instance, data encrypted via private encryption key 278 may be decrypted via public encryption key 279. In another instance, data encrypted via public encryption key 279 may be decrypted via private encryption key 278.

In one or more embodiments, interface 280 may include circuitry that enables communicatively coupling to one or more devices. In one example, interface 280 may include circuitry that enables communicatively coupling to one or more buses. For instance, the one or more buses may include one or more buses described herein, among others. In a second example, interface 280 may include circuitry that enables one or more interrupt signals to be received. In one instance, interface 280 may include general purpose input/output (GPIO) circuitry, and the GPIO circuitry may enable one or more interrupt signals to be received and/or provided via at least one interrupt line. In another instance, interface 280 may include GPIO circuitry that may enable BMC 130 to provide and/or receive signals associated with other circuitry (e.g., diagnostic circuitry, etc.). In a third example, interface 280 may include circuitry that enables communicatively coupling to one or more networks. In one instance, interface 280 may include circuitry that enables communicatively coupling to network interface 180. In another example, interface 280 may include a network interface.

In one or more embodiments, one or more of OS 262 and APPs 264-268 may include processor instructions executable by processor 220. In one example, processor 220 may execute processor instructions of one or more of OS 262 and APPs 264-268 via non-volatile memory medium 270. In another example, one or more portions of the processor instructions of the one or more of OS 262 and APPs 264-268 may be transferred to volatile memory medium 250, and processor 220 may execute the one or more portions of the processor instructions of the one or more of OS 262 and APPs 264-268 via volatile memory medium 250. In one or more embodiments, processor 220 may execute instructions in accordance with at least a portion of one or more systems, at least a portion of one or more flowcharts, one or more methods, and/or at least a portion of one or more processes described herein. For example, non-volatile memory medium 270 and/or volatile memory medium 250 may store instructions that may be executable in accordance with at least a portion of one or more systems, at least a portion of one or more flowcharts, at least a portion of one or more methods, and/or at least a portion of one or more processes described herein. In one or more embodiments, processor 220 may execute instructions in accordance with at least a portion of one or more of systems, flowcharts, at least a portion of one or more methods, and/or at least a portion of one or more processes described herein. For example, non-volatile memory medium 270 and/or volatile memory medium 250 may store instructions that may be executable in accordance with at least a portion of one or more of systems, at least a portion of one or more flowcharts, at least a portion of one or more methods, and/or at least a portion of one or more processes described herein. In one or more embodiments, processor 220 may utilize BMC data 277. In one example, processor 220 may utilize BMC data 277 via non-volatile memory medium 270. In another example, one or more portions of BMC data 277 may be transferred to volatile memory medium 250, and processor 220 may utilize BMC data 277 via volatile memory medium 250.

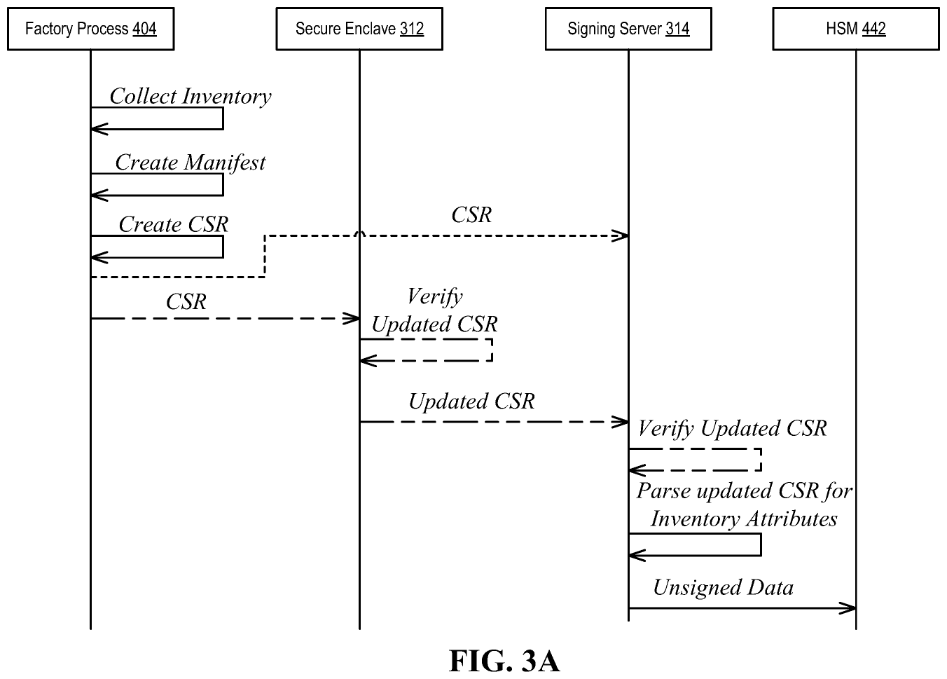

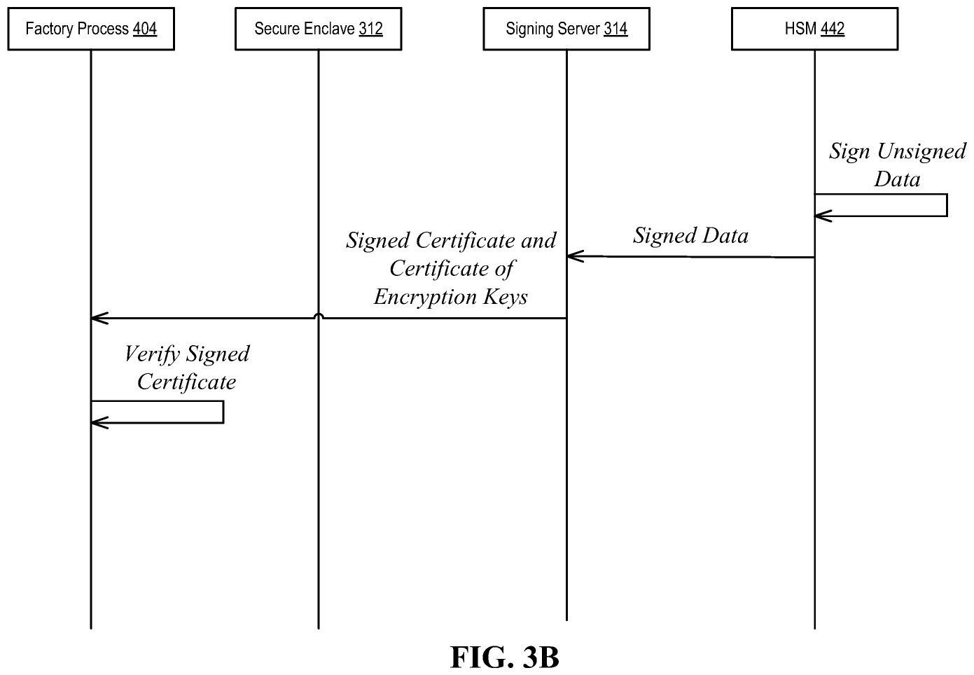

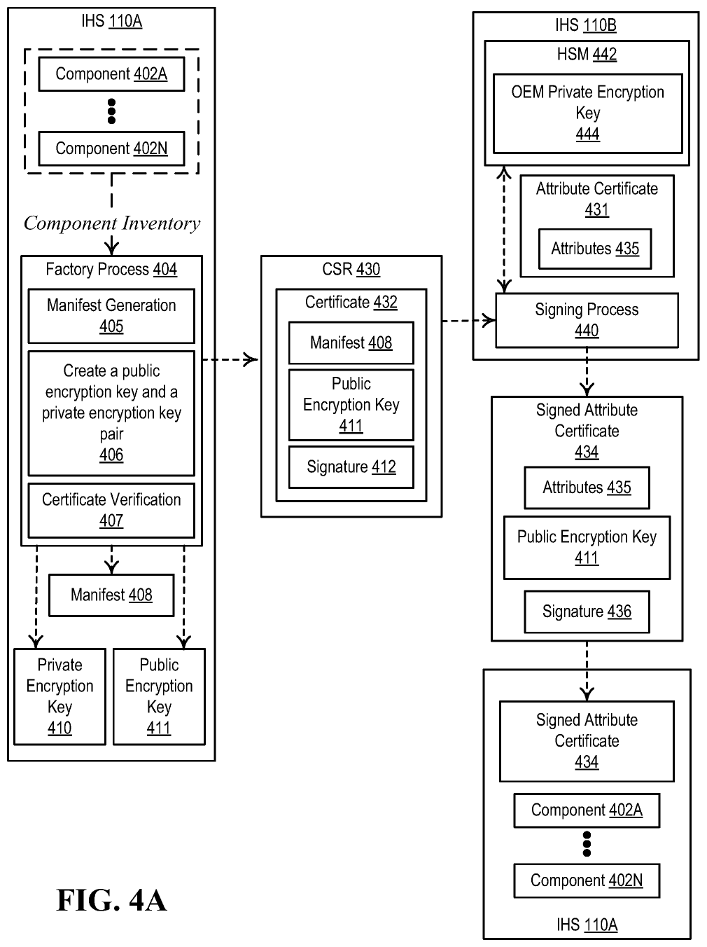

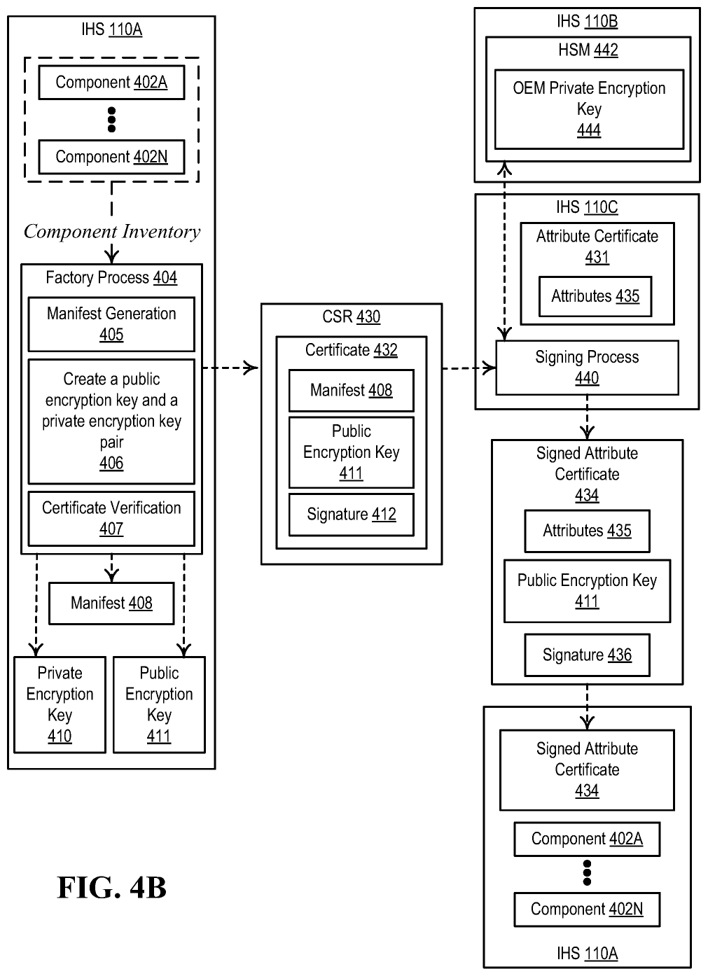

Turning now to FIGS. 3A and 3B, examples of sequence diagrams of creating an attribute certificate is illustrated, according to one or more embodiments. In one or more embodiments, a factory process may be executed on an OEM produced information handling. For example, a factory process 404 (illustrated in FIGS. 4A and 4B) may be executed on an IHS 110A (illustrated in FIGS. 4A and 4B). In one or more embodiments, factory process 404 may be executed within a Microsoft Windows PE (WinPE) environment. For example, the WinPE environment may be or may include an operating system (e.g., a small operating system), which may be utilized to install, deploy, and/or repair a Microsoft Windows operating system (e.g., for Microsoft Windows operating system editions such as “Home”, “Pro”, “Enterprise”, “Server”, “Education”, etc.). For instance, WinPE environment may be utilized to: set up a hard drive before installing a Microsoft Windows operating system, install a Microsoft Windows operating system by utilizing applications and/or scripts from a network or a local drive (e.g., a local hard drive, a local DVD-ROM, etc.), capture a Microsoft Windows operating system image, apply a Microsoft Windows operating system image, modify a Microsoft Windows operating system while the Microsoft Windows operating system is not executing on a processor (e.g., processor 120), set up one or more automatic recovery tools, recover data from one or more unbootable devices (e.g., an unbootable hard disk drive, an unbootable solid state drive, etc.), add a custom shell to automate one or more tasks (e.g., one or more set up, configure, and/or recovery tasks), and/or add a custom graphical user interface (GUI) to automate tasks to automate one or more tasks (e.g., one or more set up, configure, and/or recovery tasks), among others. In one or more embodiments, IHS 110A may be a system under test (SUT).

In one or more embodiments, factory process 404 may create a public encryption key 410 and a private encryption key 411. For example, factory process 404 may include a process 406, which may create a public encryption key and a private encryption key pair as public encryption key 410 and private encryption key 411. In one or more embodiments, the factory process may collect inventory information associated with one or more components of the OEM produced information handling. For example, factory process 404 may collect inventory information associated with one or more components 402A-402N (illustrated in FIGS. 4A and 4B) of IHS 110A.

In one or more embodiments, one or more of components 402A-402N may include one or more of processor 120, BMC 130, volatile memory medium 150, non-volatile memory medium 160, non-volatile memory medium 160, non-volatile memory medium 170, I/O subsystem 175, network interface 180, and one or more expansion cards, among others. For example, an expansion card may include a graphics card, a network card, a RAID (redundant array of inexpensive disks) card, a non-volatile memory medium card, a cryptography card, an audio processing card, a video processing card, an audio/video processing card, a physics processing card, an artificial intelligence card, a host adapter card, or a clock card, among others. For instance, an expansion card may be compliant with a PCIe interface, among others.

In one or more embodiments, the factory process may create a manifest that includes inventory information for each of the multiple components of the OEM produced information handling. For example, factory process 404 may create a manifest 408 that includes inventory information for each of multiple components 402A-402N of IHS 110A. Although IHS 110A is illustrated with multiple components 402A-402N, IHS 110A may include any number of multiple components, according to one or more embodiments.

In one or more embodiments, a certificate signing request (CSR) may be created. For example, factory application 404 may create a CSR 430 (illustrated in FIGS. 4A and 4B). In one or more embodiments, CSR 430 may include one or more of a certificate 432, a public key 411, and a signature 412 (illustrated in FIGS. 4A and 4B), among others. For example, signature 412 may include an encrypted hash value of manifest 408. For instance, a hash value of manifest 408 may be encrypted with a private encryption key 410 (illustrated in FIGS. 4A and 4B) to produce signature 412. In one or more embodiments, certificate 432 may be or may include a X.509 certificate. In one or more embodiments, certificate 432 may be compliant with a X.509 certificate.

In one or more embodiments, the CSR may be provided to a secure enclave 312 (e.g., IHSFW 172) or may be provided to a signing server 314. In one example, factory application 404 may provide CSR 430 to secure enclave 312. In one instance, secure enclave 312 may verify and update CSR 430. In another instance, secure enclave 312 may provide an updated CSR 430 to signing server 314. In another example, factory application 404 may provide CSR 430 to signing server 314. In one or more embodiments, CSR 430 may include a certificate 432 may include manifest 408, a public encryption key 411, and a signature 412.

In one or more embodiments, signing server 314 may include an information handling system that executes signing process 440. In one example, signing server 314 may include an IHS 110B (illustrated in FIGS. 4A and 4B). In another example, signing server 314 may include IHS 110C (illustrated in FIGS. 4A and 4B). In one or more embodiments, signing server 314 may be or may include the OEM certificate authority. In one or more embodiments, signing server 314 may be or may include a web server.

In one or more embodiments, signing server 314 may verify and update CSR 430 when signing server 314 receives CSR 430 from factory process 404. In one or more embodiments, signing server 314 may verify the updated CSR 430 when signing server 314 receives updated CSR 430 from secure enclave 312. In one or more embodiments, signing server 314 may parse updated CSR 430 for inventory attributes. For example, the inventory attributes may be attributes 435 (illustrated in FIGS. 4A and 4B).

In one or more embodiments, signing server 314 may provide unsigned data to a high security module (HSM) 442 (illustrated in FIGS. 4A and 4B). In one example, the unsigned data may include an attribute certificate 431 (illustrated in FIGS. 4A and 4B). In another example, the unsigned data may include attributes 435. In one or more embodiments, signing server 314 may include HSM 442. In one or more embodiments, HSM 442 may be external to signing server 314. In one or more embodiments, a HSM may include a physical computing device that safeguards and manages digital keys (e.g., encryption keys), may perform encryption and decryption processes for digital signatures, may perform strong authentication, and/or may perform other cryptographic processes. In one example, a HSM may include a plug-in card, which may be installed in an information handling system. In another example, a HSM may include an external device, which may be communicatively coupled to an information handling system. In one or more embodiments, a HSM may include one or more secure integrated circuits (ICs). In one or more embodiments, a HSM may support one or more symmetric encryption processes and/or may support one or more asymmetric encryption processes. For example, the one or more asymmetric encryption processes may include a certificate authority process and a digital signing process, among others.

In one or more embodiments, HSM 442 may sign the unsigned data to produce signed data. In one example, HSM 442 may sign attribute certificate 431. For instance, the signed data may include signed attribute certificate 436. In another example, HSM 442 may sign attributes 435. For instance, HSM 442 may produce signature 436 from signing attributes 435. As an example, the signed data may include attributes 435 and signature 436 (illustrated in FIGS. 4A and 4B).

In one or more embodiments, signing server 314 may provide, to factory process 404, a signed certificate and a certificate of encryption keys that were utilized to sign and may create the signed certificate. For example, signing server 314 may provide, to factory process 404, a signed attribute certificate 434 (illustrated in FIGS. 4A and 4B) and a certificate of encryption keys that were utilized to sign and create signed certificate 434. For instance, signed attribute certificate 434 may include one or more of attributes 435, public encryption key 411, and signature 436, among others. In one or more embodiments, signed attribute certificate 434 may be or may include a signed X.509 certificate. In one or more embodiments, signed attribute certificate 434 may be compliant with a signed X.509 certificate. In one or more embodiments, the certificate of encryption keys that were utilized to sign and create signed certificate 434 may be utilized to validate signed certificate 434. For example, each of the encryption keys that were utilized to sign and create signed certificate 434 may be or may include a trust anchor.

In one or more embodiments, factory process 404 may verify signed certificate 434. In one example, verifying signed certificate 434 may include determining that signed certificate 434 has not been tampered with. In a second example, verifying signed certificate 434 may include determining that signed certificate 434 includes information from manifest 408 (e.g., inventory data) associated with components 402A-402N. In another example, verifying signed certificate 434 may include verifying the encryption keys that were utilized to sign and create signed certificate 434. For instance, verifying the encryption keys that were utilized to sign and create signed certificate 434 may include verifying attributes 435 in a reverse order based at least on the encryption keys that were utilized to sign and create signed certificate 434. In one or more embodiments, factory process 404 may include a certificate verification process 407 (illustrated in FIGS. 4A and 4B), which may verify signed certificate 434.

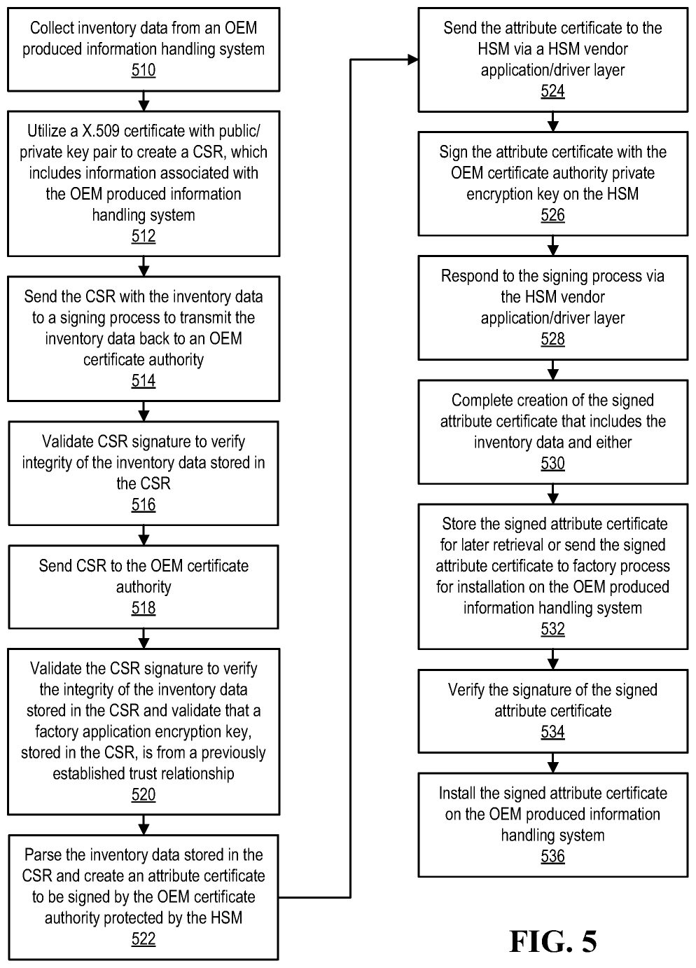

Turning now to FIG. 5, an example of a method of creating an attribute certificate is illustrated, according to one or more embodiments. At 510, inventory data from an OEM produced information handling system may be collected. For example, factory process 404 may collect inventory data from IHS 110A. For instance, the inventory data from IHS 110A may include information associated with one or more of components 402A-402N. In one or more embodiments, the inventory data from the OEM produced information handling system may be stored via manifest 408.

At 512, a X.509 certificate with a public encryption key and a private encryption key pair may be utilized to create a CSR, which includes information associated with the OEM produced information handling system. For example, factory process 404 may utilize certificate 432 with public encryption key 410A and private encryption key 411A to create CSR 430, which includes information associated with IHS 110A. For instance, information associated with IHS 110A may include manifest 408. In one or more embodiments, factory process 404 may create certificate 432. In one example, certificate 432 may be or may include a X.509 certificate. In another example, certificate 432 may be compliant with a X.509 certificate.

In one or more embodiments, BMC 130 may sign certificate 432. For example, factory process 404 may provide certificate 432 to BMC 130 for BMC 130 to sign certificate 432. For example, BMC 130 may sign certificate 432 utilizing private encryption key 278. In one or more embodiments, a signature of certificate 432 that utilized private encryption key 278 may be included in CSR 430. In one or more embodiments, IHSFW 172 may sign certificate 432. For example, factory process 404 may provide certificate 432 to IHSFW 172 for IHSFW 172 to sign certificate 432. For example, IHSFW 172 may sign certificate 432 utilizing private encryption key 174. In one or more embodiments, a signature of certificate 432 that utilized private encryption key 174 may be included in CSR 430.

At 514, the CSR with the inventory data may be sent to a signing process to transmit the inventory data back to an OEM certificate authority. For example, factory process 404 may send CSR 430 to signing process 440 to transmit inventory data to HSM 442. For instance, HSM 442 may be an OEM certificate authority. At 516, a CSR signature may be validated to verify integrity of the inventory data stored in the CSR. For example, signing process 440 may validate a signature associated with CSR 430 to verify integrity of manifest 408.

At 518, the CSR may be sent to the OEM certificate authority. For example, HSM 442 may be or may include the OEM certificate authority. In one instance, BMC 130 may send CSR 430 to HSM 442. In another instance, factory process 404 may send CSR 430 to HSM 442. At 520, the CSR signature may be validated to verify the integrity of the inventory data stored in the CSR, and a factory application encryption key (e.g., public encryption key 411) stored with in the CSR may be validated as from a previously established trust relationship. In one example, signing process 440 may validate the CSR signature to verify the integrity of the inventory data stored in the CSR and validate that a factory application encryption key, stored in the CSR, is from a previously established trust relationship. In another example, factory process 404 may validate the CSR signature to verify the integrity of the inventory data stored in the CSR and validate that a factory application encryption key, stored in the CSR, is from a previously established trust relationship. In one or more embodiments, if a public encryption key stored in the CSR is not from a previously established trust relationship, the CSR may not be signed by the OEM certificate authority. For example, the OEM certificate authority may only sign a CSR that includes a public encryption key, stored in the CSR, if the public encryption key is associated with a previously trusted relationship.

At 522, the inventory data stored in the CSR may be parsed, and an attribute certificate to be signed by the OEM certificate authority protected by the HSM may be created. For example, signing process 440 may parse the inventory data stored in the CSR and may create attribute certificate 431 to be signed by the OEM certificate authority protected by HSM 442. For instance, signing process 440 may parse manifest 408 and may create attribute certificate 431 to be signed by the OEM certificate authority protected by HSM 442. As an example, signing process 440 may create attributes of attribute certificate 431 based at least on manifest 408.

At 524, the attribute certificate may be sent to the HSM via a HSM vendor application/driver layer. For example, signing process 440 may send the attribute certificate to the HSM via a HSM vendor application/driver layer. At 526, the attribute certificate may be signed with the OEM certificate authority private encryption key on the HSM. For example, HSM 442 may sign attribute certificate 431 with OEM private encryption key 444.

At 528, the HSM may respond to the signing process via the HSM vendor application/driver layer. For example, HSM 442 may respond to signing process 440 via the HSM vendor application/driver layer. At 530, creation of the signed attribute certificate that includes the inventory data may be completed. For example, HSM 442 may complete creation of the signed attribute certificate that includes the inventory data. For instance, HSM 442 may complete creation of the signed attribute certificate that includes manifest 408. In one or more embodiments, completing creation of the signed attribute certificate that includes the inventory data may include adding signature 436 to attribute certificate 431, which includes manifest 408, to produce signed attribute certificate 434.

At 532, the signed attribute certificate may be stored for later retrieval or may be sent to factory process for installation on the OEM produced information handling system. In one example, HSM 442 store signed attribute certificate 434 for later retrieval. In another example, HSM 442 may send signed attribute certificate 434 to factory process 440 for installation on IHS 110A. At 534, the signature of the signed attribute certificate may be verified. For example, factory process 404 may verify signature 436 of signed attribute certificate 434.

In one or more embodiments, attributes 435 of signed attribute certificate 434 may be verified. For example, factory process 404 may verify attributes 435 of signed attribute certificate 434. For instance, verifying attributes 435 of signed attribute certificate 434 may include comparing attributes 435 with manifest 408. As an example, comparing attributes 435 with manifest 408 may include determining that information stored via manifest 408 is represented via attributes 435. In one or more embodiments, verifying attributes 435 of signed attribute certificate 434 may include verifying components represented in attributes 435 match information associated with components 402A-402N. For example, factory process 404 may verify that components represented in attributes 435 match information associated with components 402A-402N. At 536, the signed attribute certificate may be installed on the OEM produced information handling system. For example, factory process 404 may install the signed attribute certificate on IHS 110A.

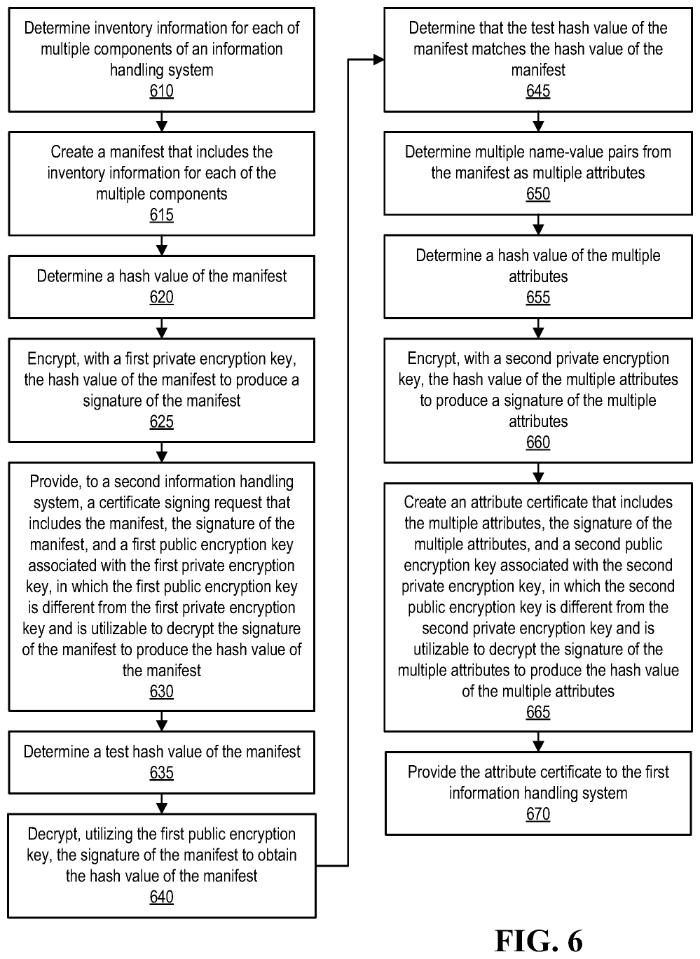

Turning now to FIG. 6, an example of a method of operating a system is illustrated, according to one or more embodiments. At 610, inventory information for each of multiple components of a first information handling system may be determined. For example, the first information handling system may be IHS 110A. For instance, inventory information for each of components 402A-402N of IHS 110A may be determined. In one or more embodiments, determining inventory information for each of multiple components of the first information handling system may include collecting inventory information for each of multiple components of the first information handling system. In one or more embodiments, inventory information for a component of the first information handling system may include one or more or a manufacturer identification, a model identification, a media access control (MAC) address, an capacity of data storage, a clock frequency identification, and a version identification, among others. For example, an identification may include a string of characters.

At 615, a manifest that includes the inventory information for each of the multiple components may be created. For example, IHS 110A may create manifest 408 that includes the inventory information for each of multiple components 402A-402N. For instance, factory application 404 may create manifest 408 that includes the inventory information for each of multiple components 402A-402N. As an example, a process 405 (e.g., a manifest generation process illustrated in FIGS. 4A and 4B) may create manifest 408 that includes the inventory information for each of multiple components 402A-402N. Although IHS 110A is illustrated with multiple components 402A-402N, IHS 110A may include any number of multiple components, according to one or more embodiments. At 620, a hash value of the manifest may be determined. For example, IHS 110A may determine a hash value of manifest 408. For example, IHS 110A may determine a hash value of manifest 408. For instance, factory application 404 may determine a hash value of manifest 408.

In one or more embodiments, a hash value of data may be determined via a one-way hash function. In one example, a one-way hash function may be relatively easy to compute. For instance, for data x (e.g., a number, a string, binary data, etc.) and a one-way hash function h, h(x) may be relatively easy to compute. In another example, a one-way hash function may significantly difficult to reverse. For instance, for the one-way hash function h and a hash value h(z), z may be significantly difficult to compute. In one or more embodiments, significantly difficult to compute may mean that it may take years to compute z from h(z), even if multiple computers were applied to such a task.

In one or more embodiments, a one-way hash function may be considered collision free. For example, the one-way hash function may be injective or one-to-one. For instance, h(z₁) and h(z₂) may produce different values, where z₁ and z₂ are different. In one or more embodiments, a one-way hash function may be considered a cryptographic checksum, a message digest, a digital fingerprint, a message integrity check, a contraction function, a compression function, and/or a manipulation detection code, among others. Examples of one-way hash functions may include one or more of an Abreast Davies-Meyer, a Davies-Meyer, a message digest (MD) 2, a MD 4, a MD 5, a RIPE-MD, a GOST Hash, a N-HASH, a HAVAL, a SHA (secure hash algorithm) (e.g., SHA-1, SHA-2, SHA-3, SHA-256, SHA-384, etc.), and a SNEFRU, among others. In one or more embodiments, a one-way hash function may be a composite function of two or more one-way hash functions. For example, a function h₁ may include a MD 5 one-way hash function h₂, a SHA one-way hash function h₃, and a MD 5 one-way hash function h₄, such that h₁=h₂(h₃(h₄(z))). For instance, a one-way hash function that is a composite function of two or more one-way hash functions may be considered to be and/or said to be strengthened.

At 625, the hash value of the manifest may be encrypted, with a first private encryption key, to produce a signature of the manifest. For example, IHS 110A may encrypt, with private encryption key 410, the hash value of manifest 408 to produce signature 412 of manifest 408. In one instance, factory application 404 may encrypt, with private encryption key 410, the hash value of manifest 408 to produce signature 412 of manifest 408. In another instance, BMC 130 may encrypt, with private encryption key 410, the hash value of manifest 408 to produce signature 412 of manifest 408. Private encryption key 410 may be private encryption key 278, for example.

In one or more embodiments, a private encryption key and a public encryption key may be utilized in an asymmetric encryption process. For example, the private encryption key and the public encryption key may be asymmetric encryption keys. For instance, the public encryption key may be derived from the private encryption key. As such, the public encryption key may be different from the private encryption key, for example. In one or more embodiments, the private encryption key and the public encryption key may be utilized to encrypt data to produce encrypted data, and the private encryption key and the public encryption key may be utilized may be utilized to decrypt encrypted data to produce data, which was encrypted. In one example, the private encryption key may be utilized to encrypt data to produce encrypted data. In a second example, public encryption key may be utilized to decrypt encrypted data to produce data, which was encrypted with the private encryption key. In a third example, the public encryption key may be utilized to encrypt data to produce encrypted data. In another example, the private encryption key may be utilized to decrypt encrypted data to produce data, which was encrypted with the public encryption key.

At 630, a certificate signing request that includes the manifest, the signature of the manifest, and a first public encryption key associated with the first private encryption key, in which the first public encryption key is different from the first private encryption key and is utilizable to decrypt the signature of the manifest to produce the hash value of the manifest, may be provided to a second information handling system. In one example, IHS 110A may provide, to IHS 110B, certificate signing request 432 that includes manifest 408, signature 412 of manifest 408, and public encryption key 411 associated with private encryption key 410, in which public encryption key 411 is different from private encryption key 410 and is utilizable to decrypt signature 412 of manifest 408 to produce the hash value of manifest 408. In another example, IHS 110A may provide, to IHS 110C, certificate signing request 432 that includes manifest 408, signature 412 of manifest 408, and public encryption key 411 associated with private encryption key 410, in which public encryption key 411 is different from private encryption key 410 and is utilizable to decrypt signature 412 of manifest 408 to produce the hash value of manifest 408.

At 635, a test hash value of the manifest may be determined. In one example, IHS 110B may determine a test hash value of manifest 408. For instance, signing process 440 of IHS 110B may determine a test hash value of manifest 408. In another example, IHS 110C may determine a test hash value of manifest 408. For instance, signing process 440 of IHS 110C may determine a test hash value of manifest 408.

At 640, the signature of the manifest may be decrypted, utilizing the first public encryption key, to obtain the hash value of the manifest. In one example, IHS 110B may decrypt, utilizing public encryption key 411, signature 412 of manifest 408 to obtain the hash value of manifest 408. For instance, signing process of IHS 110B may decrypt, utilizing public encryption key 411, signature 412 of manifest 408 to obtain the hash value of manifest 408. In another example, IHS 110C may decrypt, utilizing public encryption key 411, signature 412 of manifest 408 to obtain the hash value of manifest 408. For instance, signing process of IHS 110C may decrypt, utilizing public encryption key 411, signature 412 of manifest 408 to obtain the hash value of manifest 408.

At 645, it may be determined that the test hash value of the manifest matches the hash value of the manifest. In one example, IHS 110B may determine that the test hash value of manifest 408 matches the hash value of manifest 408. For instance, signing process 440 of IHS 110B may determine that the test hash value of manifest 408 matches the hash value of manifest 408. In another example, IHS 110C may determine that the test hash value of manifest 408 matches the hash value of manifest 408. For instance, signing process 440 of IHS 110C may determine that the test hash value of manifest 408 matches the hash value of manifest 408.

At 650, multiple name-value pairs may be determined from the manifest as multiple attributes. In one example, IHS 110B may determine multiple name-value pairs from manifest 408 as multiple attributes 435. For instance, signing process 440 of IHS 110B may determine multiple name-value pairs from manifest 408 as multiple attributes 435. In another example, IHS 110C may determine multiple name-value pairs from manifest 408 as multiple attributes 435. For instance, signing process 440 of IHS 110C may determine multiple name-value pairs from manifest 408 as multiple attributes 435.

At 655, a hash value of the multiple attributes may be determined. In one example, IHS 110B may determine a hash value of the multiple attributes 435. For instance, signing process 440 of IHS 110B may determine a hash value of the multiple attributes 435. In another example, IHS 110C may determine a hash value of the multiple attributes 435. For instance, signing process 440 of IHS 110C may determine a hash value of the multiple attributes 435.

At 660, the hash value of the multiple attributes may be encrypted, with a second private encryption key, to produce a signature of the multiple attributes. For example, IHS 110B may encrypt, with OEM private encryption key 444, the hash value of multiple attributes 435 to produce a signature of multiple attributes 435. For instance, HSM 442 may encrypt, with OEM private encryption key 444, the hash value of multiple attributes 435 to produce a signature of multiple attributes 435. In one or more embodiments, the second private encryption key may be different from the first encryption key. For example, OEM private encryption key 444 may be different from private encryption key 410.

At 665, an attribute certificate that includes the multiple attributes, the signature of the multiple attributes, and a second public encryption key associated with the second private encryption key, in which the second public encryption key is different from the second private encryption key and is utilizable to decrypt the signature of the multiple attributes to produce the hash value of the multiple attributes, may be created. In one example, IHS 110B may create signed attribute certificate 434 that includes multiple attributes 434, signature 436 of multiple attributes 434, and a second public encryption key associated with the second private encryption key, in which the second public encryption key is different from the second private encryption key and is utilizable to decrypt the signature of the multiple attributes to produce the hash value of the multiple attributes. For instance, signing process 440 of IHS 110B may create an signed attribute certificate that includes the multiple attributes, the signature of the multiple attributes, and a second public encryption key associated with the second private encryption key, in which the second public encryption key is different from the second private encryption key and is utilizable to decrypt the signature of the multiple attributes to produce the hash value of the multiple attributes. In another example, IHS 110C may create an attribute certificate that includes the multiple attributes, the signature of the multiple attributes, and a second public encryption key associated with the second private encryption key, in which the second public encryption key is different from the second private encryption key and is utilizable to decrypt the signature of the multiple attributes to produce the hash value of the multiple attributes. For instance, signing process 440 of IHS 110C may create an attribute certificate that includes the multiple attributes, the signature of the multiple attributes, and a second public encryption key associated with the second private encryption key, in which the second public encryption key is different from the second private encryption key and is utilizable to decrypt the signature of the multiple attributes to produce the hash value of the multiple attributes.

At 670, the attribute certificate may be provided to the first information handling system. For example, IHS 110B may provide attribute certificate 436 to IHS 110A. In one or more embodiments, the attributes of the attribute certificate may be formatted with an abstract syntax notation one (ASN.1). For example, the ASN.1 may be a standard interface description language that may be utilized in defining data structures that may be serialized and deserialized in a cross-platform fashion. For instance, ASN.1 may be utilized in computer networking, communications between or among two or more information handling systems, telecommunications, and cryptography, among others.

In one or more embodiments, one or more of the method elements and/or process elements and/or one or more portions of a method element and/or a process element may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with at least a portion of one or more flowcharts, at least a portion of one or more systems, at least a portion of one or more methods, and/or at least a portion of one or more processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system, comprising:
a first information handling system; and
a second information handling system;
wherein the first information handling system is configured to:
determine inventory information for each of a plurality of components of the first information handling system;
create a manifest that includes the inventory information for each of the plurality of components;
determine a hash value of the manifest;
encrypt, with a first private encryption key, the hash value of the manifest to produce a signature of the manifest; and
provide, to the second information handling system, a certificate signing request that includes the manifest, the signature of the manifest, and a first public encryption key associated with the first private encryption key, wherein the first public encryption key is different from the first private encryption key and is utilizable to decrypt the signature of the manifest to produce the hash value of the manifest;
wherein the second information handling system is configured to:
determine a test hash value of the manifest;
decrypt, utilizing the first public encryption key, the signature of the manifest to obtain the hash value of the manifest;
determine that the test hash value of the manifest matches the hash value of the manifest;
determine a plurality of name-value pairs from the manifest as a plurality of attributes;
determine a hash value of the plurality of attributes;
encrypt, with a second private encryption key, the hash value of the plurality of attributes to produce a signature of the plurality of attributes;
create an attribute certificate that includes the plurality of attributes, the signature of the plurality of attributes, and a second public encryption key associated with the second private encryption key, wherein the second public encryption key is different from the second private encryption key and is utilizable to decrypt the signature of the plurality of attributes to produce the hash value of the plurality of attributes; and
provide the attribute certificate to the first information handling system.

2. The system of claim 1,
wherein, to encrypt, with the second private encryption key, the hash value of the plurality of attributes to produce the signature of the plurality of attributes, the second information handling system is further configured to provide the hash value of the plurality of attributes to a high security module; and
wherein the high security module is configured to encrypt, with the second private encryption key, the hash value of the plurality of attributes to produce the signature of the plurality of attributes.

3. The system of claim 2, wherein the second information handling system includes the high security module.

4. The system of claim 1, wherein the second private encryption key is an original equipment manufacturer private encryption key.

5. The system of claim 1, wherein the first information handling system is further configured to:
determine a test hash value of the plurality of attributes;
decrypt, utilizing the second public encryption key, the signature of the plurality of attributes to obtain the hash value of the plurality of attributes; and
determine that the test hash value of the plurality of attributes matches the hash value of the plurality of attributes.

6. The system of claim 5, wherein the first information handling system is further configured to:
receive the attribute certificate;
after receiving the attribute certificate, determine the inventory information for each of the plurality of components of the information handling system; and
determine that each inventory information for each of the plurality of components is found in the plurality of attributes.

7. The system of claim 1, wherein the first information handling system is further configured to:
request the attribute certificate; and
receive the attribute certificate.

8. The system of claim 1, wherein the plurality of attributes are formatted via an abstract syntax notation one (ASN.1).

9. The system of claim 1, wherein the second information handling system is further configured to authenticate the first public encryption key.

10. The system of claim 9, wherein, to authenticate the first public encryption key, the second information handling system is further configured to:
retrieve a test public encryption key from a memory medium of the second information handling system; and
determine that the test public encryption key matches the first public encryption key.

11. A method, comprising:
determining inventory information for each of a plurality of components of an information handling system;
creating a manifest that includes the inventory information for each of the plurality of components;
determining a hash value of the manifest;
encrypting, with a first private encryption key, the hash value of the manifest to produce a signature of the manifest;
providing, to a certificate authority, a certificate signing request (CSR) that includes the manifest, the signature of the manifest, and a first public encryption key associated with the first private encryption key, wherein the first public encryption key is different from the first private encryption key and is utilizable to decrypt the signature of the manifest to produce the hash value of the manifest;
determining a test hash value of the manifest;
decrypting, by the certificate authority and utilizing the first public encryption key, the signature of the manifest to obtain the hash value of the manifest;
determining, by the certificate authority, that the test hash value of the manifest matches the hash value of the manifest;
determining, by the certificate authority, a plurality of name-value pairs from the manifest as a plurality of attributes;
determining, by the certificate authority, a hash value of the plurality of attributes;
encrypting, with a second private encryption key, the hash value of the plurality of attributes to produce a signature of the plurality of attributes;
creating, by the certificate authority, an attribute certificate that includes the plurality of attributes, the signature of the plurality of attributes, and a second public encryption key associated with the second private encryption key, wherein the second public encryption key is different from the second private encryption key and is utilizable to decrypt the signature of the plurality of attributes to produce the hash value of the plurality of attributes; and
providing, by the certificate authority, the attribute certificate to the information handling system.

12. The method of claim 11, wherein the encrypting, with the second private encryption key, the hash value of the plurality of attributes to produce the signature of the plurality of attributes includes:
providing, by the certificate authority, the hash value of the plurality of attributes to a high security module; and
encrypting, by the high security module and with the second private encryption key, the hash value of the plurality of attributes to produce the signature of the plurality of attributes.

13. The method of claim 12, wherein the certificate authority includes the high security module.

14. The method of claim 11, wherein the second private encryption key is an original equipment manufacturer private encryption key.

15. The method of claim 11, further comprising:
determining, by the information handling system, a test hash value of the plurality of attributes;
decrypting, by the information handling system and utilizing the second public encryption key, the signature of the plurality of attributes to obtain the hash value of the plurality of attributes; and
determining, by the information handling system, that the test hash value of the plurality of attributes matches the hash value of the plurality of attributes.

16. The method of claim 15, further comprising:
receiving, by the information handling system, the attribute certificate;
after the receiving the attribute certificate, determining, by the information handling system, the inventory information for each of the plurality of components of the information handling system; and
determining, by the information handling system, that each inventory information for each of the plurality of components is found in the plurality of attributes.

17. The method of claim 11, further comprising:
requesting, by the information handling system, the attribute certificate; and
receiving, by the information handling system, the attribute certificate.

18. The method of claim 11, wherein the plurality of attributes are formatted via an abstract syntax notation one (ASN.1).

19. The method of claim 11, further comprising:
authenticating, by the certificate authority, the first public encryption key.

20. The method of claim 19, wherein authenticating the first public encryption key includes:
retrieving, by the certificate authority, a test public encryption key from a memory medium of the certificate authority; and
determining, by the certificate authority, that the test public encryption key matches the first public encryption key.
